(19) United States
(12) Patent Application Publication
(10) Pub. No.: US 2006/0145936 A1
(43) Pub. Date: Jul. 6, 2006

(54) Antenna mounting

(76) Inventor: Randall A. Gage, Troy, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 11/026,662

(22) Filed: Dec. 31, 2004

(51) Int. Cl. H01Q 1/32

(52) U.S. Cl. 343/711; 343/713

(57) ABSTRACT

An antenna mounting structure includes an automotive vehicle headliner structured for mounting on an interior surface of a roof of the vehicle. The headliner includes an extended portion that extends beneath a glass component of the vehicle when the headliner is mounted on the roof. The antenna mounting structure also includes an antenna mounted on the extended portion of the headliner. The mounting of the antenna on the extended portion provides a line of sight between the antenna and a transmitter or receiver located in the atmosphere outside the vehicle.

### BACKGROUND OF THE INVENTION

This invention relates in general to antennas for radio, GPS systems, cell phones and the like, and in particular to the mounting of such antennas on automotive vehicles.

Antennas are typically mounted on vehicles by attaching them to the glass or by mounting them on the exterior of the vehicle. For example, exterior mounted antennas include shark fin style and whip style antennas. Unfortunately, these antennas create visual clutter on the vehicle exterior and detract from the design of the vehicle The exterior antennas are also at risk of vandalism. The mounting of the antennas increases the labor costs of the vehicle manufacturer. Mounting the antennas requires is drilling holes in the sheet metal of the vehicle exterior, resulting in potential leakage.

U.S. Pat. No. 6,377,220 to Cook et al. (General Motors), issued Apr. 23, 2002, discloses mounting an antenna system on a headliner of a vehicle. The location at which the antenna system is mounted may detract from its operational performance compared to a vehicle exterior mounted antenna system.

U.S. Pat. No. 6,118,410 to Nagy (General Motors and Delphi Technologies), issued Sep. 12, 2000, discloses mounting an antenna array below an extended portion of a vehicle windshield or rear window, on a shelf formed on the vehicle roof below the windshield or rear window. This design requires a modification of the design of the sheet metal of the roof and an extension of the vehicle glass, both of which add to the cost of the vehicle. The cables from the antenna array have to be routed through a hole in the roof sheet metal, further increasing the cost. It may be difficult to service the antenna array, because the glass may need to be removed to gain access to the antennas.

In view of the above, it would be desirable to provide a structure for mounting antennas on a vehicle that avoids the drawbacks of the previous mounting structures.

### SUMMARY OF THE INVENTION

This invention relates to an antenna mounting structure. The antenna mounting structure includes an automotive vehicle headliner structured for mounting on an interior surface of a roof of the vehicle. The headliner includes an extended portion that extends beneath a glass component of the vehicle when the headliner is mounted on the roof. The antenna mounting structure also includes an antenna mounted on the extended portion of the headliner. The mounting of the antenna on the extended portion provides a line of sight between the antenna and a transmitter or receiver located in the atmosphere outside the vehicle.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a plan view of the top surface of an automotive vehicle headliner including an antenna mounting structure according to the invention.

FIG. 2 is a side elevational view, partly in cross-section, of an antenna mounting structure according to the invention.

### DETAILED DESCRIPTION OF THE PREFERRED EMBODIMENT

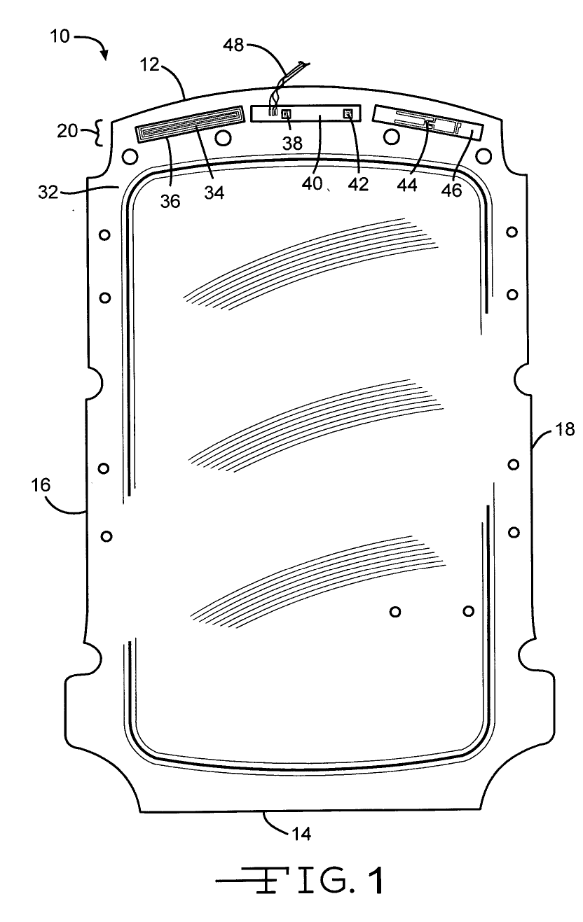

Referring now to the drawings, there is illustrated in FIG. 1 an automotive vehicle headliner 10. The headliner 10 is structured for mounting on the interior surface of the roof of the vehicle, as is well known in the automotive field. The headliner can be adapted for use in any type of automotive vehicle, including cars, trucks and SUV's. The embodiment shown in FIG. 1 is adapted for use in a Chrysler PT Cruiser.

The headliner 10 includes a leading edge 12 that is positioned toward the front of the vehicle when the headliner is mounted, a trailing edge 14 that is positioned toward the rear of the vehicle, a driver side edge 16, and a passenger side edge 18.

In accordance with the invention, the headliner 10 is modified to include an extended portion 20. The extended portion 20 extends beneath a glass component of the vehicle when the headliner is mounted on the interior surface of the vehicle roof. The glass component can be the vehicle windshield, in which case the extended portion 20 is an extension on the leading edge 12 of the headliner, as shown in FIG. 1. Alternatively, the glass component can be the rear window of the vehicle, in which case the extended portion is an extension on the trailing edge 14 of the headliner. The glass component can also be a side window or side pane of the vehicle, in which case the extended portion is an extension on one of the sides 16 or 18 of the headliner. In another embodiment, the glass component is a sun roof or moon roof of the vehicle. The headliner is modified to include an opening (not shown) that corresponds with the opening in the sun roof or moon roof, except that the headliner includes an extended portion that extends beneath part of the sun roof or moon roof. By “glass component”, as used herein, is meant any glass-covered opening that provides a line of sight between the vehicle interior and the atmosphere outside the vehicle. Typically, it is a fixed glass component. By “glass”, as used herein, is meant any transparent or translucent material, such as glass or clear plastic.

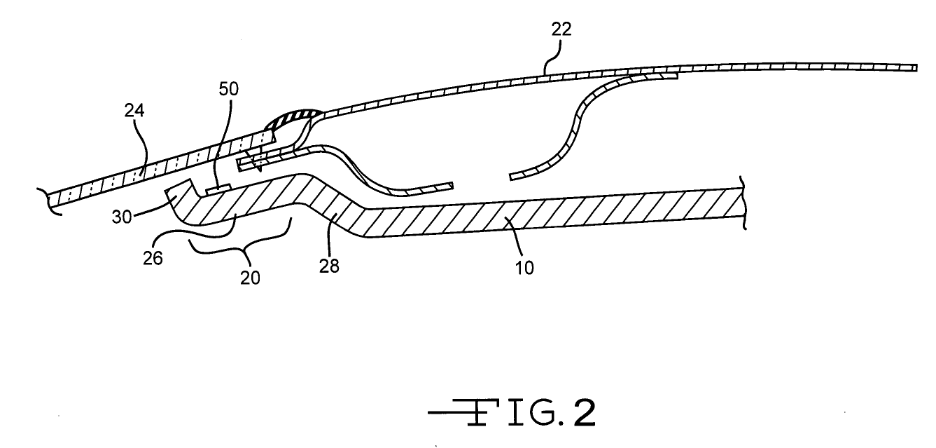

FIG. 2 shows the headliner 10 having been mounted on the interior surface of the vehicle roof 22. The headliner 10 has been modified to include an extended portion 20 that extends beneath the windshield 24 of the vehicle. A conventional headliner would only extend to the edge of the vehicle roof 22 adjacent the windshield 24. In contrast, the modified headliner 10 extends beneath the windshield 24 a sufficient distance so that one or more antennas (described below) can be mounted on the extended portion 20 and have a line of sight through the windshield 24 to the atmosphere outside the vehicle. The distance that the extended portion 20 extends beneath the windshield 24 will depend on the particular antenna(s) to be mounted. In a typical embodiment, the extended portion 20 extends past the edge of the windshield 24 a distance of at least about 1 inch, and usually between about 1 inch and about 2½ inches.

The extended portion 20 of the headliner 10 can have any structure suitable for mounting the antenna(s) as described above, and compatible with the structures of the windshield 24 and the roof 22. In the embodiment shown in FIG. 2, the extended portion 20 includes a longitudinally extending portion 26 that extends from an upwardly slanted portion 28 of the headliner 10. The longitudinally extending portion 26 of the headliner 10 extends approximately parallel with the windshield 24. The extended portion 20 also includes an upwardly curved portion 30 that extends from the longitudinally extending portion 26. The upwardly curved portion 30 extends upward almost into abutment with the interior surface of the windshield 24.

The headliner 10 can be modified to include the extended portion 20 by any suitable manufacturing method. Typically, the blank of headliner substrate will be longer at the leading edge, and the blank will be pressed into the desired shape of the headliner including the desired shape of the extended portion.

Lastly, the antenna mounting structure of the invention includes one or more antennas mounted on the extended portion 20 of the headliner 10. The antennas can be any type desirable for use with the vehicle, for example, an AM/FM radio antenna, a satellite radio antenna, a GPS navigation system antenna, and/or a cell phone antenna. Advantageously, the antenna mounting structure of the invention allows multiple antennas to be mounted in the same location. The antennas can be mounted separately side-by-side, or they can be constructed as an antenna array including multiple antennas and mounted as the array.

In FIG. 1, an antenna array is mounted on the extended portion 20 of the headliner 10, on the upper surface or “C surface” 32 of the headliner 10 (i.e., the side of the headliner 10 which faces upward away from the driver and passengers in the vehicle, toward the vehicle roof). The antenna array includes an AM/FM antenna 34 mounted on a circuit board 36, a GPS system antenna 38 mounted on another circuit board 40, a satellite radio antenna 42 mounted on the circuit board 40, and a cell phone antenna 44 mounted on another circuit board 46. In production, all the antennas would typically be mounted on a single circuit board. FIG. 1 shows cables 48 for the antennas attached to the middle circuit board 40, but in production they would all be attached to the single circuit board on which all the antennas are mounted. The cables 48 will typically extend down inside the “A pillar” (between the front door and the windshield) and through the instrument panel to the various devices requiring antennas inside the vehicle. Sometimes one or more of the devices is mounted on the headliner, and the corresponding cable would extend directly to the device.

FIG. 2 also shows an antenna array 50 mounted on the extended portion 20 of the headliner 10.

The antenna array can be mounted on the headliner by any suitable method. Preferably, the antenna array is bonded to the headliner by using a flexible adhesive, such as a hot melt adhesive or a foam-backed tape (a foam layer with adhesive layers on both sides). Because the antenna and/or the headliner may include curved or protruding portions, the use of a flexible adhesive increases the chances of good bonding along the length of the antenna. A mechanical fastener such as a plastic clip can also be used, but it is less preferred for aesthetic reasons (it would be visible to the vehicle occupants).

The antenna array can be designed as a flexible member or a structural member of the headliner assembly. If the antenna array is designed with stiffness, it can be a structural member which helps to support the headliner and prevent unwanted bending and sagging of the headliner. For example, the antenna array may be designed to have a U-shape or a rib to increases its strength and stiffness. A wide variety of configurations can be used. As another alternative, instead of using the type of circuit board shown, the circuit board can be extruded against the headliner and the antennas bonded to the extrusion.

The mounting of the antenna(s) on the extended portion 20 of the headliner 10 provides a line of sight between the antenna and a transmitter or receiver located in the atmosphere outside the vehicle. For example, a line of sight is provided between the antenna and a satellite or a tower. A GPS system needs to see a minimum of three satellites. By “line of sight”, as used herein, is meant that the signals can be received or transmitted between the antennas and the transmitter or receiver. The antenna(s) can be mounted on any part of the extended portion that allows such a line of sight. Typically, they will be mounted on the C surface of the headliner, but in some embodiments they could be mounted on the edge of the headliner.

If desired, the portion of the glass component above the antenna array can be tinted to improve the aesthetics of the vehicle, so long as the tinting does not prevent the antennas from picking up external signals or transmitting effectively.

The antenna mounting structure of the invention eliminates vehicle exterior clutter and restores the surface back to design intent. Since the invention allows the headliner to be shipped to the vehicle assembly plant with the antennas pre-attached, cost savings to the vehicle manufacturer is realized by downloading an assembly step to the headliner supplier.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. An antenna mounting structure comprising:
an automotive vehicle headliner structured for mounting on an interior surface of a roof of the vehicle, the headliner including an extended portion that extends beneath a glass component of the vehicle when the headliner is mounted on the roof; and
an antenna mounted on the extended portion of the headliner;
the mounting of the antenna on the extended portion providing a line of sight between the antenna and a transmitter or receiver located in the atmosphere outside the vehicle.

2. The antenna mounting structure defined in claim 1 wherein the extended portion of the headliner extends beneath the glass component a distance of at least about 1 inch.

3. The antenna mounting structure defined in claim 1 wherein the antenna is an antenna array including multiple antennas and a mounting structure.

4. The antenna mounting structure defined in claim 3 wherein the antenna array provides strength and stiffness to the headliner.

5. The antenna mounting structure defined in claim 3 wherein the antenna array is bonded to the headliner.

6. The antenna mounting structure defined in claim 1 wherein the glass component is a windshield or rear window of the vehicle.

7. The antenna mounting structure defined in claim 1 wherein the extended portion includes a longitudinally extending portion that extends approximately parallel with the glass component.

8. An automotive vehicle assembly including a vehicle roof, a rigid glass component of the vehicle, and an antenna mounting structure comprising:
an automotive vehicle headliner structured for mounting on an interior surface of the roof of the vehicle, the headliner including an extended portion that extends beneath the glass component of the vehicle when the headliner is mounted on the roof; and
an antenna mounted on the extended portion of the headliner;
the mounting of the antenna on the extended portion providing a line of sight between the antenna and a transmitter or receiver located in the atmosphere outside the vehicle.

9. The automotive vehicle assembly defined in claim 8 wherein the extended portion of the headliner extends beneath the glass component a distance of at least about 1 inch.

10. The automotive vehicle assembly defied in claim 8 wherein the antenna is an antenna array including multiple antennas and a mounting structure.

11. The automotive vehicle assembly defined in claim 10 wherein the antenna array provides strength and stiffness to the headliner.

12. The automotive vehicle assembly defined in claim 10 wherein the antenna array is bonded to the headliner.

13. The automotive vehicle assembly defined in claim 8 wherein the glass component is a windshield or rear window of the vehicle.

14. The automotive vehicle assembly defined in claim 8 wherein the extended portion includes a longitudinally extending portion that extends approximately parallel with the glass component.

15. An antenna mounting structure comprising:
an automotive vehicle headliner structured for mounting on an interior surface of a roof of the vehicle, the headliner including an extended portion that extends a distance of at least about 1 inch beneath a glass component of the vehicle when the headliner is mounted on the roof; and
an antenna mounted on the C surface of the extended portion of the headliner;
the mounting of the antenna on the extended portion providing a line of sight between the antenna and a transmitter or receiver located in the atmosphere outside the vehicle.

16. The antenna mounting structure defined in claim 15 wherein the antenna is an antenna array including multiple antennas and a mounting structure.

17. The antenna mounting structure defined in claim 16 wherein the antenna array provides strength and stiffness to the headliner.

18. The antenna mounting structure defined in claim 16 wherein the antenna array is bonded to the headliner.

19. The antenna mounting structure defined in claim 15 wherein the glass component is a windshield or rear window of the vehicle.

20. The antenna mounting structure defined in claim 15 wherein the extended portion includes a longitudinally extending portion that extends approximately parallel with the lass component.
